(19) United States
(12) Patent Application Publication
(10) Pub. No.: US 2024/0011131 A1
(43) Pub. Date: Jan. 11, 2024

(54) ALUMINUM ALLOY AND METHODS FOR ADDITIVE MANUFACTURING OF LIGHTWEIGHT PARTS

(71) Applicant: Airbus Defence and Space GmbH, TAUFKIRCHEN (DE)

(72) Inventors: David SCHIMBÄCK, TAUFKIRCHEN (DE); Frank PALM, TAUFKIRCHEN (DE)

(21) Appl. No.: 18/255,246

(22) PCT Filed: Nov. 26, 2021
(86) PCT No.: PCT/EP2021/083084

§ 371 Date: May 31, 2023

(30) Foreign Application Priority Data
Dec. 1, 2020 (DE) 10 2020 131 823.5

(51) Int. Cl. C22C 21/06; C22C 21/00; C22C 1/02; B22F 9/00; B22F 9/04; B22F 10/28; B33Y 70/00; B33Y 10/00; B33Y 40/20; B22F 10/64

(52) U.S. Cl. CPC C22C 21/06; C22C 21/003; C22C 1/02; B22F 9/008; B22F 9/04; B22F 10/28; B33Y 70/00; B33Y 10/00; B33Y 40/20; B22F 10/64; B22F 2999/00; B22F 2998/10; B22F 2301/052; B22F 2009/048

(57) ABSTRACT

An aluminum (Al) alloy consisting of titanium (Ti) with a proportion of 0.1 wt % to 15 wt %; scandium (Sc) with a proportion of 0.1 wt % to 3.0 wt %; zirconium (Zr) with a proportion of 0.1 wt % to 3.0 wt %; manganese (Mn) with a proportion of 0.1 wt % to 3.0 wt %; and a balance Al and unavoidable impurities with a total of less than 0.5 wt %. The alloy is used in an additive manufacturing method for manufacturing high strength, high ductile lightweight parts for aircraft. The alloy may be initially produced as a powder that is remelted during the manufacturing process.

### CROSS-REFERENCES TO RELATED APPLICATIONS

This application is a national phase of International Patent Application No. PCT/US2021/083084 filed on Nov. 20, 2021, which in turn claims priority to German Patent Application No. 10 2020 131 823.5 filed on Dec. 1, 2020, the entire disclosures of which are incorporated herein by way of reference.

### FIELD OF THE INVENTION

The invention relates an aluminum alloy, a method for additive manufacturing of lightweight parts using the aluminum alloy powder and lightweight parts manufactured with this method.

### BACKGROUND OF THE INVENTION

Aluminum alloys represent an important material for the production of lightweight components for aircraft. The reduction in the overall weight of aircraft associated with the installation of these lightweight components enables fuel costs to be cut. The aluminum alloys used for this purpose must also have high tensile strength, ductility, toughness and corrosion resistance in the interests of flight safety.

Examples of aluminum alloys that can be used in aircraft production are those designated AA2024, AA7349 and AA6061. In addition to the base metal, they contain aluminum, magnesium and copper as essential alloying partners and also manganese, zirconium, chromium, iron, silicon, titanium and/or zinc, either mandatory or optional.

An important further development are the scandium-containing aluminum alloys, which are commercially available from APWorks GmbH under the product name Scalmalloy, for example. They exhibit even higher strength, ductility and corrosion resistance than the alloys mentioned above. Scandium shows the highest increase in strength of all transition metals by precipitation hardening of Al₃Sc. However, because of the low solubility of scandium in aluminum (about 0.3 wt % at about 660° C.), Scalmalloy must be produced by rapid solidification, such as melt spinning, of a melt and subsequent precipitation hardening to form secondary Al₃Sc precipitates in the aluminum matrix.

For further information on Scalmalloy, please refer to the publications “Scalmalloy®—A unique high strength and corrosion insensitive AlMgScZr material concept” (A. J. Bosch, R. Senden, W. Entelmann, M. Kniiwer, F. Palm, “Proceedings of the 11th Internacional Conference on Aluminum Alloys in: “Aluminum Alloys: Their physical and mechanical properties”, J. Hirsch, G. Gottstein, B. Skrotzki, Wiley-VCH) and “Metallurgical peculiarities in hyper-eutectic AlSc and AlMgSc engineering materials prepared by rapid solidification processing” (F. Palm, P. Vermeer, W. von Bestenbostel, D. Isheim, R. Schneider (loc. cit.).

Unpublished German patent application 10 2020 131 823.5, Table 1 according to FIG. 1 lists chemical compositions of the abovementioned aluminum alloys, which can be used for manufacturing lightweight parts for aircraft.

Another advantage of Scalmalloy is that it is suitable for additive manufacturing of lightweight components. In addition to processes such as wire arc additive manufacturing (WAAM), it is particularly suitable for laser powder bed fusion. This additive manufacturing process is also referred to below as L-PBF process (L-PBF=Laser Powder Bed Fusion). The number of alloys that can be used for this process is limited. According to WO 2018/144323, reliable additive manufacturing in the L-PBF process is possible with the alloys Scalmalloy, AlSi₁₀Mg, TiAl₆V₄, CoCr and Inconel 718, while the vast majority of the more than 5,500 alloys used today are not suitable for the L-PBF process or 3D printing.

Reference is made to unpublished German patent application 10 2020 131 823.5, the disclosure of which is incorporated herein by reference.

### SUMMARY OF THE INVENTION

It is an object of the invention to provide an improved aluminum alloy that is suitable for additive manufacturing, such as by laser powder bed fusion.

The object may be achieved by the subject-matter of one or more embodiments described herein. Preferred embodiments are subject-matter of the dependent claims.

The invention provides an aluminum (Al) alloy consisting of:
titanium (Ti) with a proportion of 0.1 wt % to 15 wt %;
scandium (Sc) with a proportion of 0.1 wt % to 3.0 wt %;
zirconium (Zr) with a proportion of 0.1 wt % to 3.0 wt %;
manganese (Mn) with a proportion of 0.1 wt % to 3.0 wt %;
balance Al and unavoidable impurities with a total of less than 0.5 wt %; and
optionally at least one first additional alloy element that is chosen from a group consisting of tantalum (Ta), hafnium (Hf), Yttrium (Y), and erbium (Er), wherein an individual proportion of an individual first additional alloy element does not exceed 2.0 wt % and the total proportion of the first additional alloy elements does not exceed 3.0 wt %;
optionally at least one second additional alloy element that is selected from a group consisting of vanadium (V), niobium (Nb), chromium (Cr), molybdenum (Mo), silicon (Si), iron (Fe), and cobalt (Co), wherein the individual proportion of an individual second additional alloy element does not exceed 3.0 wt %, preferably does not exceed 2.0 wt %, and the total proportion of the second additional alloy elements does not exceed 3.0 wt %;
optionally at least one third additional alloy element that is selected from a group consisting of magnesium (Mg) or calcium (Ca), wherein the individual proportion of an individual third additional alloy element is smaller than 2.0 wt %, and the total proportion of the third additional alloy elements does not exceed 3.0 wt %.

Preferably, Mn has a proportion of 0.1 wt % to 6 wt %, preferably 0.1 wt % to 4 wt %, preferably 0.1 wt % to 2.5 wt %, preferably 0.1 wt % to 2.0 wt %, more preferably of 1.0 wt % to 2.0 wt %.

Preferably, Ti has a proportion of 0.5 wt % to 5.0 wt %, Sc has a proportion from 0.2 wt % to 1.5 wt %, Zr has a proportion of 0.20 wt % to 0.70 wt %.

Preferably, Ti has a proportion of 1.0 wt % to 5.0 wt %, Sc has a proportion of 0.5 wt % to 1.0 wt %, and Zr with a proportion of 0.2 wt % to 0.8 wt %.

Preferably, Ti has a proportion of 1.0 wt % to 5.0 wt %, Sc has a proportion of 0.6 wt % to 1.1 wt %, preferably from 0.70 wt % to 0.80 wt % or from 0.95 wt % to 1.05 wt %, Zr has a proportion of 0.20 wt % to 0.50 wt %, more preferably from 0.30 wt % to 0.40 wt %.

Preferably, Ti has a proportion of up to 2.0 wt %, preferably 1.0 wt % to 2.0 wt %, and the alloy consists only of Al, Mn, and metals that have an enthalpy of vaporization that is greater than that of Al or that have a smaller vapor pressure than that of Al.

Preferably, Ti has a proportion of more than 2.0 wt % to 5.0 wt %, preferably of more than 3.0 wt % to 5.0 wt %, and Mn has a proportion of 0.1 wt % to 2.0 wt %, preferably of 1.0 wt % to 2.0 wt %.

Preferably, the alloy consists only of Al, Mn, and metals that have an enthalpy of vaporization that is greater than that of Al or that have a smaller vapor pressure than that of Al.

Preferably, the alloy is free of magnesium (Mg) and/or calcium (Ca) and/or nickel (Ni).

The invention provides a method for additive manufacturing of a lightweight part precursor from a preferred aluminum alloy, the method comprising:
a) melting the metals into an aluminum alloy melt;
b) cooling or letting cool the aluminum alloy melt
b1) in a quick solidification process having a cooling speed of 1.000 K/s to K/s, preferable of 100.000 K/s to 1.000.000 K/s, such as melt spinning, powder atomizing by means of gas or in water, thin strip casting or spray compacting, and obtaining a solidified and if applicable powdery aluminum alloy with scandium included in solid solution; or
b2) in a cooling process and obtaining a solidified aluminum alloy;
c) crushing the aluminum alloy of step b1) or b2) into a powder.

Preferably, in step b) or step b1) the cooling speed is maintained for at least the temperature range of 1,800 K to 500 K.

The invention provides a method for additive manufacturing a lightweight part precursor from a preferred aluminum alloy, the method comprising:
d) manufacturing a powder bed from the powder obtained in step c) of the above method;
e) additive manufacturing of a three-dimensional lightweight part precursor in a laser melting process in the powder bed with a laser by locally melting the powder and cooling or letting cool the locally melted portion and obtaining a lightweight part precursor from an aluminum alloy having therein scandium in a solid solution.

The invention provides a method for manufacturing of a lightweight part, the method comprising heat treating the lightweight part precursor obtained in the above method at a temperature that hardens the lightweight part precursor due to precipitation hardening.

The invention provides a lightweight part precursor obtainable by a preferred method.

The invention provides a lightweight part obtainable by a preferred method.

The invention provides a use of a preferred aluminum alloy or of a powder obtainable by a preferred method for manufacturing a lightweight part precursor by selective laser melting or for manufacturing of a light-weight part by selective laser melting and subsequent precipitation hardening.

The idea disclosed herein is a further development of an aluminum alloy that is described in unpublished German patent application 10 2020 131 823.5. The alloy comprises the following elements:
Ti with a proportion of 0.1 to 15.0 wt %,
Sc with a proportion of 0.1 to 3.0 wt %,
Zr with a proportion of 0.1 to 3.0 wt %,
balance Al and unavoidable impurities.

Due to the adaption to the process boundary conditions, a fine-grained microstructure can be adjusted, which can lead to exceptional mechanical properties. Products which can take advantage of this material are suitable for structural applications for lightweight construction and design, preferably in aircraft.

Different aluminum alloys have already been investigated in Al—Mg—Sc (Scalmalloy®) and Al—Cr—Sc (Scancromal®) alloy design strategies. The Al—Ti—Sc (Scantital®) alloy design strategy is a process that builds on both former investigated materials.

Due to the high Mg content of Scalmalloy®, the additive manufacturing process is not always easy do control. Scancromal® has a relatively coarse microstructure that is not necessarily suitable for all applications, such as structural applications. The addition of titanium allows that no alloying element is present with a high vapor pressure to evaporate during the process, thereby improving the additive manufactured parts.

Several advantages are associated with the addition of Ti. The L-PBF process is stable due to the absence of metals with high vapor pressure or low enthalpy of vaporization, such as Mg or Zn. Ti increases strength through grain refinement by precipitating coherent, primary Al₃X phases (X=Ti, Zr, Sc), which act as nucleation sites together with the high constitutional supercooling that occurs when Ti is added. Strength increases due to precipitation hardening of secondary phases during subsequent post heat treatment. An AlSc alloy containing additional Ti shows even better corrosion resistance.

Ti does not cause as large an increase in strength at room temperature in an aluminum alloy as Sc or Zr. Most Ti remains dissolved in the solid solution during rapid solidification. Coarsening of precipitates occurs more slowly than predicted. The creep resistance or fatigue strength (“creep resistance”) is increased.

As a further development, manganese is introduced to this alloy in order to further improve strength with simultaneously enabling higher ductility. Omission of Mg can be used for enhanced corrosion resistance. The addition of Mn compared to the first evolution of Scantital leads to an increased strength level. Mn has a significant impact onto the ductility.

The idea is based on an AlTiScMn alloy that is ultimately produced via laser powder bed fusion (L-PBF) additive manufacturing and the rapid cooling exhibited by this process.

One suggested nominal composition in percentage by weight (wt %) of the alloy is AlTi₍₁₋₅₎Sc_{0.75}Zr_{0.35}Mn₍₀₋₂₎.

The chemical driving force F_{ch} for precipitation is significantly larger for Al₃Zr than for Al₃Ti. The elastic strain energy of Al₃Ti during precipitation Fₑₗ (“elastic strain energy for precipitation”) prevents nucleation and is seven times greater than the elastic strain energy of Al₃Zr. During rapid cooling, up to 2 wt % Ti can be force-dissolved in the aluminum matrix.

An advantage of Ti in additive manufacturing of lightweight parts by the L-PBF process (or SLM process from “selective laser melting”) of aluminum alloy is its low vapor pressure or high enthalpy of vaporization. The vapor pressure of Ti is lower than that of the base metal aluminum. The enthalpy of vaporization of Ti is higher than that of the base metal aluminum. This improves process stability in that a much quieter molten bath is produced during remelting compared with aluminum alloys containing magnesium.

Ti ensures strong constitutional undercooling during solidification, which leads to the activation of potent primary nucleation sites in the melt and thus results in grain refinement. The fine microstructure increases the strength of the aluminum alloy according to Hall-Petch (strength increase is inversely proportional to grain size according to d\hat{ }(−½)).

Zr provides effective nucleation sites in the melt already at high temperatures, because Al₃Zr is precipitated already at about 900° C. and can therefore be activated by constitutional supercooling. In contrast, Al₃Sc precipitates only shortly before the solidus temperature.

When the molten aluminum alloy is cooled in step b), if the cooling rate is not too high, as when the melt is poured into a crucible, an aluminum matrix is formed in which the alloying elements Ti, Sc and Zr are present mainly in the form of large primary precipitates. When the above aluminum alloy is cooled very rapidly, as at a rate of 1,000 K/s to 10,000,000 K/s, the solidified aluminum alloy contains the above alloying elements essentially in solid solution. Precipitation of primary phases is suppressed by rapid cooling. The faster the melt is cooled, the lower is the proportion of primary precipitates. In subsequent precipitation hardening at temperatures around 250 to 450° C., for example, nano-scale, coherent Al₃X phases (X=Ti, Zr, Sc) are precipitated, which greatly improve the strength of the aluminum alloy.

In step e), after the powder has been melted by the laser beam, very rapid cooling takes place, during which the alloying elements essentially solidify in solid solution. In total, this process step is a remelting into the desired alloy.

### DETAILED DESCRIPTION OF THE PREFERRED EMBODIMENTS

Embodiments of the invention are now described in more detail.

A) Process for the Production of Aluminum Alloys

### Example 1 Production of Powdered Aluminum Alloys

In an inert crucible, 0.75 wt % Sc, 0.35 wt % Zr, 1.0 wt % Ti, 1.0 wt % Mn and 96.9 wt % Al are melted. The melt can be homogenized before further processing.

An initial portion of the melt is poured into an inert crucible where it cools and solidifies. During cooling, primary Al3Sc, Al3Zr and Al3Ti phases precipitate. The resulting material is crushed into a powder that can be used for selective laser melting in a powder bed.

A second portion of the melt is poured onto a rotating copper roll cooled with water in a melt spinning process. The melt cools at a rate of 1,000,000 K/s forming a strip. The melt cools so rapidly that the formation of Al3Sc, Al3Zr and Al3Ti is completely or substantially suppressed. The ribbon is cut into short flakes.

The alloy material obtained from the two cooling processes is reduced to a powder that can be used for selective laser melting in a powder bed.

### Example 2 Production of Powdered Aluminum Alloys with Different Titanium Content

The above process is repeated with the proportion of Ti increased to 3.0 wt %, 5.0 wt %, 10.0 wt % and 15.0 wt % and the proportion of Al decreased accordingly. The proportion of Sc, Zr and Mn remains unchanged.

### Example 3 Production of a Powdered Aluminum Alloy with Vanadium Content

The process of Example 1 is repeated, with an additional 2.0 wt % of vanadium being added to the crucible and the content of Ti, Sc and Zr being kept constant.

### Example 4 Production of a Powdered Aluminum Alloy with Nickel Content

The process of Example 1 is repeated with an additional 1.2 wt % nickel added to the crucible and the content of Ti, Sc and Zr kept constant.

### Example 5 Production of Powdered Aluminum Alloy with Chromium-Vanadium Content

The process of Example 1 is repeated with an additional 1.0 wt % vanadium and 2.0 wt % chromium added to the crucible and the titanium content increased to 5 wt %. The Zr content remains unchanged.

### Example 6 Production of Powdered Aluminum Alloy with Different Mn Content

The process according to Example 1 or 2 is repeated, whereby the proportion of Mn is changed to 0.1 wt %, 0.2 wt %, 0.3 wt, 0.4 wt %, 0.5 wt %, 1.5 wt %, 2.0 wt %, 2.5 wt %, 4 wt %, and 6 wt %, with the proportion of Al being adjusted accordingly.

B) Process for the Production of a Lightweight Precursor by the L-PBF Process.

In each case, an aluminum alloy powder from one of the above examples 1 to 6 is added to a system for additive manufacturing by selective laser melting, forming a powder bed. The laser beam is moved over the three-dimensional powder bed according to the digital information, whereby the powder bed is lowered step by step and new powder layers are applied. The cooling of the spot-melted aluminum alloy is so fast that scandium, zirconium and titanium are completely or essentially or predominantly frozen in solid solution, irrespective of the other composition of the aluminum alloy and irrespective of whether the powder has been produced by normal cooling or rapid cooling, for example at a rate of 1,000,000 K/sec. After completion of the scanning process, the aluminum alloy component precursor is removed from the powder bed.

C) Process for Producing a Lightweight Component

The component precursor produced in B) is heated to a temperature, such as in the range of 250° C. to 450° C., preferably 300° C. to 400° C. and even more preferably 325° C. to 350° C., at which precipitation of various Al3X phases (X=Ti, Zr, Sc or any non-stoichiometric mixture of the individual elements) occurs. Al3Ti is also precipitated, but compared to Al3Sc and Al3Zr, a predominant or larger proportion of the titanium remains in solid solution.

In summary, the invention relates to an aluminum (Al) alloy consisting of titanium (Ti) with a proportion of 0.1 wt % to 15 wt %; scandium (Sc) with a proportion of 0.1 wt % to 3.0 wt %; zirconium (Zr) with a proportion of 0.1 wt % to 3.0 wt %; manganese (Mn) with a proportion of 0.1 wt % to 3.0 wt %; and a balance Al and unavoidable impurities with a total of less than 0.5 wt %. The alloy is used in an additive manufacturing method for manufacturing high strength, high ductile lightweight parts for aircraft. The alloy may be initially produced as a powder that is remelted during the manufacturing process, whereby the desired features are achieved.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1.-15. (canceled)

16. An aluminum (Al) alloy consisting of:
0.1 wt % to 15 wt % titanium (Ti);
0.1 wt % to 3.0 wt % scandium (Sc);
0.1 wt % to 3.0 wt % zirconium (Zr);
0.1 wt % to 10.0 wt % manganese (Mn);
less than 0.5 wt % unavoidable impurities; and,
balance Al,
optionally at least one first additional alloy element selected from a group consisting of: tantalum (Ta), hafnium (Hf), Yttrium (Y), and erbium (Er), wherein an individual proportion of an individual first additional alloy element does not exceed 2.0 wt % and a total proportion of all first additional alloy elements does not exceed 3.0 wt %;
optionally at least one second additional alloy element selected from a group consisting of: vanadium (V), niobium (Nb), chromium (Cr), molybdenum (Mo), silicon (Si), iron (Fe), and cobalt (Co), wherein an individual proportion of each second additional alloy element does not exceed 3.0 wt %, and a total proportion of all second additional alloy elements does not exceed 3.0 wt %; and,
optionally at least one third additional alloy element selected from a group consisting of: magnesium (Mg) and calcium (Ca), wherein an individual proportion of each third additional alloy element is less than 2.0 wt %, and a total proportion of all third additional alloy elements does not exceed 3.0 wt %.

17. The aluminum alloy according to claim 16, wherein Mn has a proportion of 0.1 wt % to 6 wt %.

18. The aluminum alloy according to claim 16, wherein Ti has a proportion of 0.5 wt % to 5.0 wt %, Sc has a proportion from 0.2 wt % to 1.5 wt %, and Zr has a proportion of 0.20 wt % to 0.70 wt %.

19. The aluminum alloy according to claim 18, wherein Ti has a proportion of 1.0 wt % to 5.0 wt %, Sc has a proportion of 0.5 wt % to 1.0 wt %, and Zr with a proportion of 0.2 wt % to 0.8 wt %.

20. The aluminum alloy according to claim 16, wherein Ti has a proportion of 1.0 wt % to 5.0 wt %, Sc has a proportion of 0.6 wt % to 1.1 wt %, and Zr has a proportion of 0.20 wt % to 0.50 wt %.

21. The aluminum alloy according to claim 16, wherein Ti has a proportion of up to 2.0 wt %, and the alloy consists only of Al, Mn, and metals that have an enthalpy of vaporization that is greater than that of Al or that have a smaller vapor pressure than that of Al.

22. The aluminum alloy according to claim 16, wherein Ti has a proportion of more than 2.0 wt % to 5.0 wt %, and Mn has a proportion of 0.1 wt % to 2.0 wt %.

23. The aluminum alloy according to claim 16, consisting only of Al, Mn, and metals that have an enthalpy of vaporization that is greater than that of Al or that have a smaller vapor pressure than that of Al.

24. The aluminum alloy according to claim 16, wherein the alloy is free of magnesium (Mg), or calcium (Ca), or nickel (Ni), or any combination thereof.

25. A method for additive manufacturing of a lightweight part precursor from the aluminum alloy according to claim 16, the method comprising:
a) melting the metals into an aluminum alloy melt;
b) cooling the aluminum alloy melt or letting the aluminum alloy melt cool
b1) in a solidification process having a cooling speed of 1,000 K/s to K/s, and obtaining a solidified, when applicable, powdery aluminum alloy with scandium included in solid solution; or
b2) in a cooling process and obtaining a solidified aluminum alloy; and,
c) crushing the aluminum alloy of step b1) or b2) into a powder.

26. The method of claim 25 further comprising:
d) manufacturing a powder bed from the powder obtained in step c); and,
e) additive manufacturing of a three-dimensional part precursor in a laser melting process in the powder bed with a laser by locally melting the powder and cooling or letting cool a locally melted portion and obtaining the three-dimensional part precursor.

27. The method of claim 26, further comprising:
heat treating the three-dimensional part precursor oat a temperature that hardens the three-dimensional part precursor due to precipitation hardening.

28. A part obtained by the method according to claim 27.

29. A part precursor obtained by the method according to claim 26.

30. The method of claim 25, wherein the solidification process of step b1 comprises melt spinning, powder atomizing with gas or in water, thin strip casting or spray compacting, and obtaining a solidified and, when applicable, powdery aluminum alloy with scandium included in solid solution.
